(19) United States
(12) Patent Application Publication
(10) Pub. No.: US 2007/0019334 A1
(43) Pub. Date: Jan. 25, 2007

(54) Magnetic recording and reproducing apparatus

(76) Inventors: Akihisa Obata, Yokohama (JP); Masami Takada, Fujisawa (JP); Yoshio Uemura, Hitachinaka (JP); Yoshiharu Yamashita, Yokohama (JP); Kemmei Masuda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/414,174

(22) Filed: May 1, 2006

(30) Foreign Application Priority Data
Jul. 19, 2005 (JP) 2005-207959

(51) Int. Cl. G11B 5/52

(52) U.S. Cl. 360/271.6

(57) ABSTRACT

Magnetic recording and reproducing apparatuses are narrowed in track pitch as one method of increasing the respective recording capacities. It has become evident, however, that the shocks and/or vibration applied during operation has critical effects on recording/reproduction, and it has thus become essential to improve shock resistance and vibration resistance. In a rotating magnetic head drum device including a lower fixed drum, an upper fixed drum, and a magnetic head, the upper face of the upper fixed drum and a cassette holder face are secured using a vibration suppressor plate to improve shock resistance and vibration resistance.

### CLAIM OF PRIORITY

The present application claims priority from Japanese application Serial No. JP 2005-207959, filed on Jul. 19, 2005, the content of which is hereby incorporated by reference into this application.

### BACKGROUND OF THE INVENTION

1. Field of the Invention

The present invention relates to a magnetic recording and reproducing apparatus, such as a digital VTR or a tape streamer, that uses a rotating magnetic head drum device to implement high-density, high-transfer-rate recording. More particularly, the invention concerns a structure that improves shock resistance and vibration resistance.

2Description of the Related Art

The conventional technology that gives consideration to shocks and vibration, described in, for example, Japanese Patent Laid-open No. 5-242439, is intended to effectively avoid changes in the cylindricality level of a drum device due to shocks from various directions in a simplified configuration and to easily adjust the cylindricality level. Also, the above drum device is constructed so that a first drum-abutting face for holding an upper drum and a lower drum by coming into contact with these upper and lower drums at circular arc faces having radii agreeable to the drums, and a second drum-abutting face for holding the upper drum and the lower drum by coming into contact with an upper or lower edge of the upper or lower drum or with a plane essentially parallel to the upper or lower edge, at a notch formed in the upper or lower drum, are integrally molded to make it possible to effectively avoid changes in the cylindricality level of the drum device due to shocks from various directions and to adjust the cylindricality level easily on the second drum-abutting face side.

### SUMMARY OF THE INVENTION

Magnetic recording and reproducing apparatuses with increased recording capacities and capable of recording at higher transfer rates are in growing need in recent years. To increase its recording capacity, such an apparatus needs to be reduced in recording wavelength and in recording track pitch. The levels of the signals handled, however, are also reduced very significantly by the reducing operations. Techniques that allow signals of even a very small level to be read out by applying either a magnetoresistive (MR) head or a giant magnetoresistive (GMR) head as a reproducing head are already established to solve or improve the above problems.

A higher transfer rate is achieved by increasing the rotating speed of a rotating magnetic head drum device or by increasing the number of recording channels. Problems associated with contact between the magnetic head and a magnetic recording tape due to the increase in the rotating speed of the rotating magnetic head drum device are improved by modifying the structure thereof. Rotating magnetic head drum devices are divided into two types. One type employs an upper-drum rotating scheme in which a magnetic head is secured to an upper drum and in which the entire upper drum rotates with respect to a lower drum. The other type employs a middle-drum rotating scheme in which an upper drum and a lower drum are secured to a fixed shaft and in which a middle rotating drum with a magnetic head rotates about the fixed shaft, along the clearance between the upper and lower drums.

In the upper-drum rotating scheme, the rotation of the upper drum entraps air, forms an air film between a magnetic recording tape and the upper drum, and particularly during fast rotation of the upper drum, results in unstable contact between the magnetic head and the magnetic recording tape. The middle rotating drum scheme, however, is characterized in that since the upper and lower drums are secured and only the middle rotating drum rotates, this scheme is not easily affected by an air film.

It has been mentioned earlier herein that an MR head is employed as a reproducing head to read out very small signals. In recent years, however, rotating magnetic head drum devices employ a construction in which a signal amplifier (preamplifier) and other circuit components are provided on a middle rotating drum to further suppress the effects of noise and the like. Although these circuit components are designed to ensure the best achievable balance of their layout for minimum influence on the rotation of the middle rotating drum, the rotating magnetic head drum device itself is constructed to be finally balanced by a balance correction plate and other components. Since the circuit components, the balance correction plate, and other components are arranged above the installation surface of the magnetic head, the center of gravity of the device is in a high position and thus the fixed shaft suffers oscillation due to shocks or vibration. It has become evident that in particular, the shocks or vibration applied during the operation of a magnetic recording and reproducing apparatus narrowed in recording track pitch for increased recording capacity will cause, during recording, disturbances in image quality and/or increases in rewrite ratio (especially in a re-recording ratio in case of a data-recording failure) due to changes in track pitch, and during reproduction, disturbances in image quality and/or increases in reread ratio (especially in a signal re-reproducing ratio in case of a data-reproducing failure).

As described above, since the magnetic recording and reproducing apparatuses in recent years are narrowed in recording track pitch for increased recording capacity, it has become absolutely necessary to avoid the effects of shocks and/or vibration on recording and reproducing characteristics.

An object of the present invention is to improve shock resistance/vibration resistance during operation of a magnetic recording and reproducing apparatus having a rotating magnetic head drum device of a shaft-fixed, middle rotating drum type.

In order to attain the above object, a magnetic recording and reproducing apparatus of the present invention is constructed to include: a lower fixed drum with an outer peripheral side face formed as a tape-traveling surface for guiding a magnetic recording tape; an upper fixed drum fixed coaxially with the lower fixed drum, the upper fixed drum having an outer peripheral face as another tape-traveling surface for guiding the magnetic recording tape; a rotating magnetic head drum device with a middle rotating drum installed in coaxially rotatable form between the lower fixed drum and the upper fixed drum, the middle rotating drum having a magnetic head; a mechanism chassis for securing a bottom face of the lower fixed drum; and a cassette holder secured to the mechanism chassis; wherein an upper face of the upper fixed drum is secured to the cassette holder via a vibration suppressor plate.. In this construction, the rotating magnetic head drum device is secured in two (upper and lower) places, that is, the bottom side of the device is secured to the mechanism chassis and the upper side of the device is secured to the vibration suppressor plate via the cassette holder. Since the vibration suppressor plate does not need to be highly accurate, shocks and vibration can be avoided with minimum increases in costs.

In addition, the upper fixed drum has convex portions on its upper face, the vibration suppressor plate includes opposed claws at the sections that abut on the convex portions, and the opposed claws of the vibration suppressor plate are secured to the convex portions. Thus, the vibration suppressor plate and the upper fixed drum can be secured without using a screw, and increases in costs can be minimized as a result.

As described above, according to the present invention, oscillation of a fixed shaft due to shocks or vibration can be suppressed and this, in turn, allows resistance to shocks and vibration during operation to be improved.

### BRIEF DESCRIPTION OF THE DRAWINGS

FIG. 1 is a perspective view of a magnetic recording and reproducing apparatus according to a first embodiment of the present invention;

FIG. 2 is an enlarged view of section A-A′of the above magnetic recording and reproducing apparatus as viewed from direction B;

FIG. 3 is a cross-sectional view of a rotating magnetic head drum device in the first embodiment of the present invention;

FIG. 4 illustrates an example of a vibration suppressor plate in the first embodiment of the present invention;

FIG. 5 illustrates the surface of an upper fixed drum in a second embodiment of the present invention;

FIG. 6 illustrates an upper fixed drum in a fourth embodiment of the present invention;

FIG. 7 illustrates a vibration suppressor plate in a third embodiment of the present invention;

FIG. 8 illustrates a vibration suppressor plate in the fourth embodiment of the present invention;

FIG. 9 shows patterns that were recorded in a conventional drive not having a vibration suppressor plate; and

FIG. 10 shows patterns that were recorded in the drive of the present invention that has a vibration suppressor plate.

### DESCRIPTION OF THE PREFERRED EMBODIMENTS

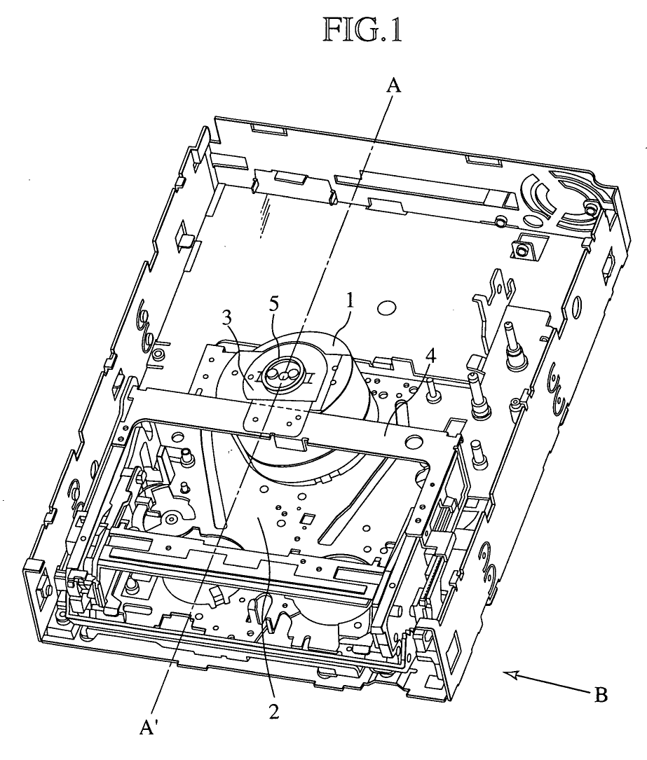

Embodiments of a magnetic recording and reproducing apparatus, inclusive of a rotating magnetic head drum device, of the present invention will be described hereunder with reference to FIGS. 1 to 10.

(First Embodiment)

FIG. 1 is a perspective view of a magnetic recording and reproducing apparatus, inclusive of a rotating magnetic head drum device, according to a first embodiment of the present invention. In the magnetic recording and reproducing apparatuses that employ helical scanning, a magnetic recording head scans obliquely with respect to a magnetic recording tape. A rotating magnetic head drum device 1 is secured to a drum installation surface (not shown) formed on a mechanism chassis 2 at a desired angle. The rotating magnetic head drum device 1 also employs a construction in which an end of a vibration suppressor plate 3 is inserted into a convex portion 5 formed on an upper face of the drum device 1 and in which another end of the vibration suppressor plate 3 is secured to a cassette holder 4 fixed to the mechanism chassis 2. In addition, the cassette holder 4 is fixed to the mechanism chassis 2 with screws or the like.

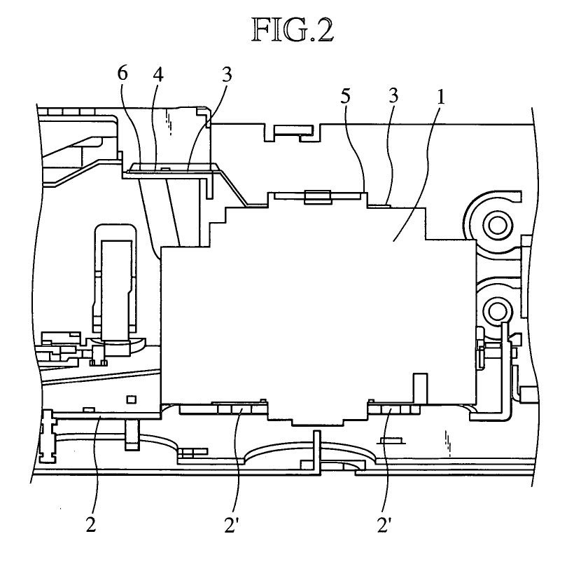

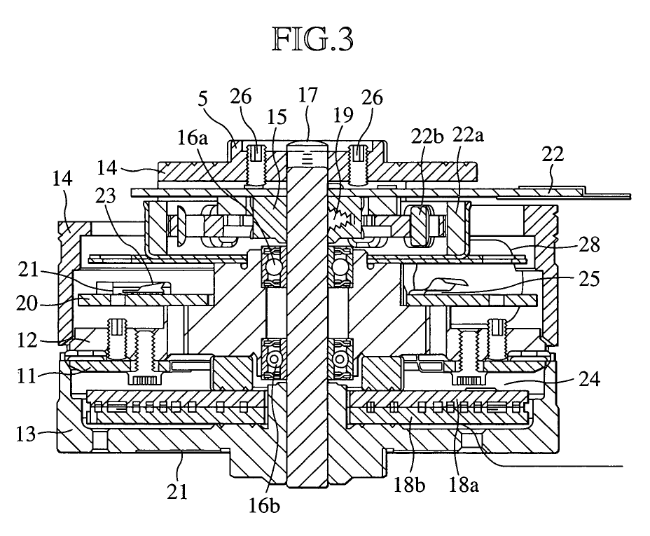

FIG. 2 shows neighboring portions of the rotating magnetic head drum device 1 in the magnetic recording and reproducing apparatus of FIG. 1 in enlarged vertical cutaway view with respect to a bottom face (reference face) of the head drum device 1, along dotted line A-A′, as viewed from direction B in FIG. 1. The rotating magnetic head drum device 1 described here is of a shaft-fixed, middle rotating drum type. A sectional interior of the rotating magnetic head drum device 1 is not described here since the sectional interior will be described in detail per FIG. 3.

The bottom face (reference face) of the rotating magnetic head drum device 1 is secured to drum installation surface 2′of the mechanism chassis 2 with screws (not shown). One end of the vibration suppressor plate 3 is fitted into the convex portion 5 on the upper face of the rotating magnetic head drum device 1, and another end of the vibration suppressor plate 3 is secured to the cassette holder 4 with a two-sided adhesive tape 6.

FIG. 3 is a cross-sectional view of the rotating magnetic head drum device. A construction of the rotating magnetic head drum device 1 of the shaft-fixed middle rotating drum type is described below using FIG. 3.

A shaft 17 is press-fitted into a lower fixed drum 13. A bottom face of the lower fixed drum 13 functions as a reference face 27 when the rotating magnetic head drum device 1 is secured to the chassis 2. Reference number 12 denotes a middle rotating drum, which has a mounted magnetic head 11 and rotates around the shaft 17 while being controlled to a desired rotating speed. Reference numbers 16a, 16b denote ball bearings. A preloading metallic fitting 15 fixed to the shaft 17 with a setscrew 19 applies a preload to the ball bearings 16a, 16b. Reference number 22a denotes a motor rotor, which is installed at an upper edge of the middle rotating drum 12. Reference number 22b denotes a motor coil assembly, and reference number 22c denotes a motor stator. An upper fixed drum 14 is fastened with the motor stator 22c by means of fastening screws 26, to an upper edge of the preloading metallic fitting 15 installed via the setscrew 19. A circuit board 20 is installed in the middle rotating drum 12 by use of installation screws (not shown). The magnetic head 11 has a flexible board 23 installed therein with one end of the flexible board wired into/onto the magnetic head 11, and this end is connected to a connector 21 of the circuit board 20. The circuit board 20 also includes a rotational transformer connection connector 25, to which is connected a rotational transformer flexible board 24 extending from a rotational transformer rotor 18a. A rotational transformer stator 18b is disposed to face the rotational transformer rotor 18a, and signals are electromagnetically exchanged between the stator 18b and the rotor 18a. A balance correction plate 28 for correcting a balance of the middle rotating drum 12 is fitted above the circuit board 20. Convex portions 5 between which the vibration suppressor plate can be inserted are formed on an upper face of the upper fixed drum 14.

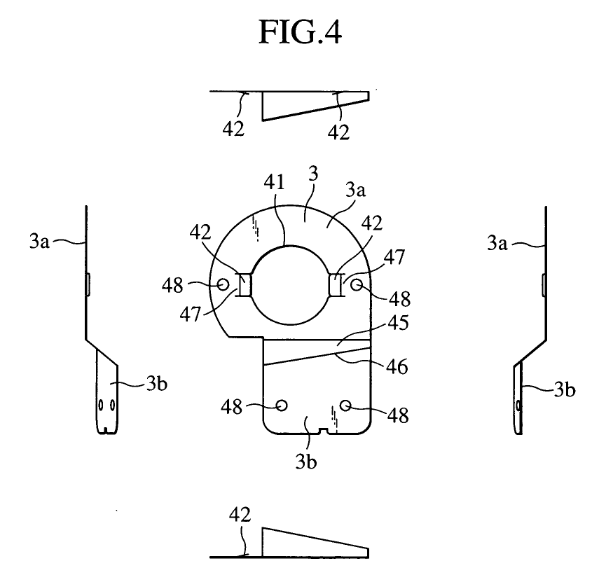

FIG. 4 shows an example of the vibration suppressor plate 3. Details thereof are described below.

The vibration suppressor plate 3 is formed of stainless steel 0.2 mm thick. In order to fix the upper face of the upper fixed drum 14 and face of the cassette holder 4 that differ in angle, the vibration suppressor plate 3 has folds 45, 46 and is bent to form a desired angle between a side face 3a of the drum and a side face 3b of the cassette holder. The vibration suppressor plate 3 also has an installation hole 41 to allow the insertion of the vibration suppressor plate 3 between the convex portions 5 on the upper drum 14. In addition, the vibration suppressor plate 3 is formed with opposed claws 42 folded at folds 47 to prevent it from coming off during shocks and vibration. The claws 42 are particularly effective when the vibration suppressor plate 3 is fixedly fitted between the convex portions 5 on the upper drum 14. The claws 42 may be omitted when an adhesive such as a two-sided adhesive tape is to be used for fixing on the upper fixed drum 14. When screws are not to be used for fixing, screw installation holes 48 can also be omitted.

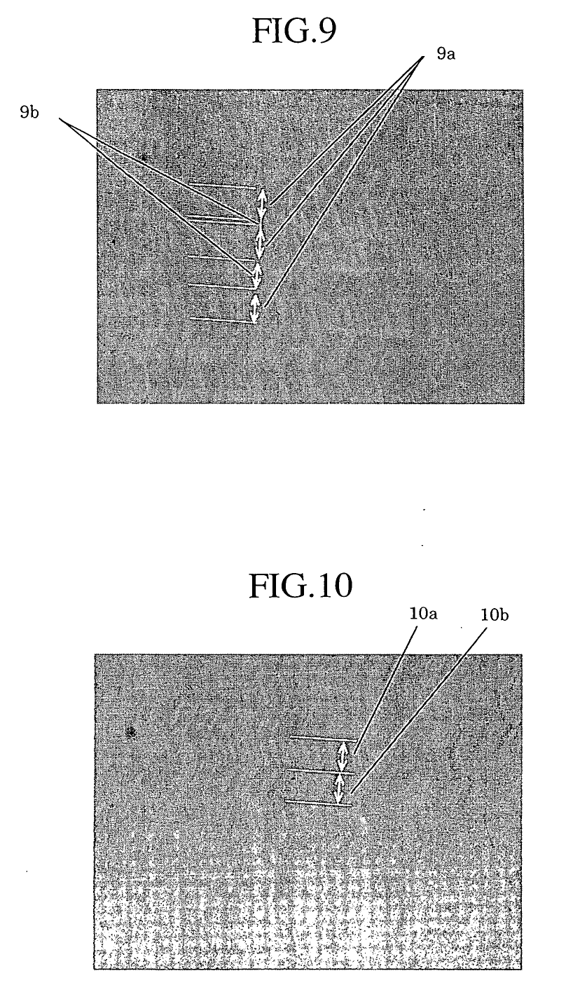

Next, an avoidability level of any influence of vibration on recording track pitch in the present embodiment is described below per FIGS. 9 and 10. Patterns that were recorded in a conventional magnetic recording and reproducing apparatus not having a vibration suppressor plate are shown in FIG. 9, and patterns that were recorded in the magnetic recording and reproducing apparatus of the present invention that has a vibration suppressor plate are shown in FIG. 10. These figures show photographs of the recording track pitch observations obtained when the respective magnetic recording and reproducing apparatuses were operated to record patterns under required vibration.

For the patterns of FIG. 9 that were recorded in the conventional magnetic recording and reproducing apparatus not having a vibration suppressor plate, a change (difference) in track pitch is observed between a pattern width 9a of a pattern that was recorded using a magnetic head of channel 1 (ch 1), and a pattern width 9b of a pattern that was recorded using a magnetic head of ch 2. Disturbances in image quality and/or increases in rewrite ratio, therefore, easily arise from the change in track pitch. However, for the patterns of FIG. 10 that were recorded in the magnetic recording and reproducing apparatus having a vibration suppressor plate, essentially no change (difference) in track pitch is observed between a pattern width 10a of a pattern that was recorded using a magnetic head of channel 1 (ch 1), and a pattern width 10b of a pattern that was recorded using a magnetic head of ch 2. Disturbances in image quality and/or increases in rewrite ratio, therefore, do not occur.

As described above, the rotating magnetic head drum device is secured in two (upper and lower) places, that is, the bottom side of the device is secured to the mechanism chassis and the upper side of the device is secured to the vibration suppressor plate via the cassette holder. Since the vibration suppressor plate does not need to be highly accurate, shocks and vibration can be avoided with minimum increases in costs.

(Second Embodiment)

In FIGS. 1 to 4, a description has been given of the rotating magnetic head drum device 1 constructed to have the convex portions 5 on the upper face of the upper fixed drum 14. The following describes another embodiment including an upper fixed drum 14:

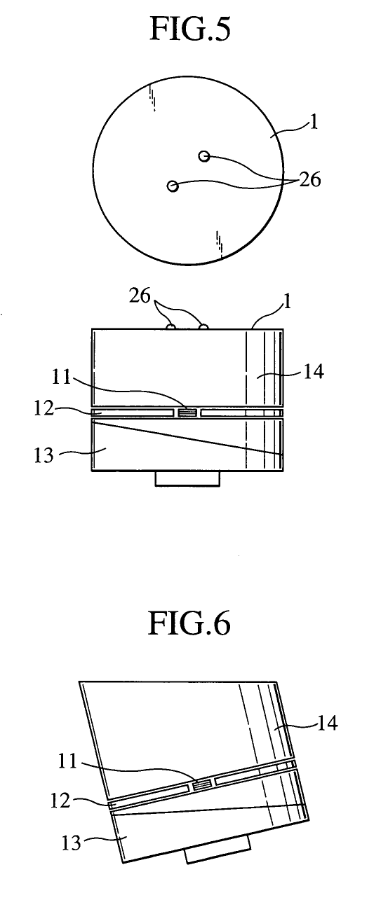

FIG. 5 is a schematic diagram showing an upper fixed drum 14 in the second embodiment. The upper fixed drum 14 has no concave or convex portions on an upper face. In this case, the upper fixed drum and a vibration suppressor plate 3 are fixed using screws and/or an adhesive such as a two-sided adhesive tape.

In FIG. 5, screw holes, although not shown, may be provided as necessary in the upper face of the upper fixed drum 14 to install the vibration suppressor plate 3 thereon.

(Third Embodiment)

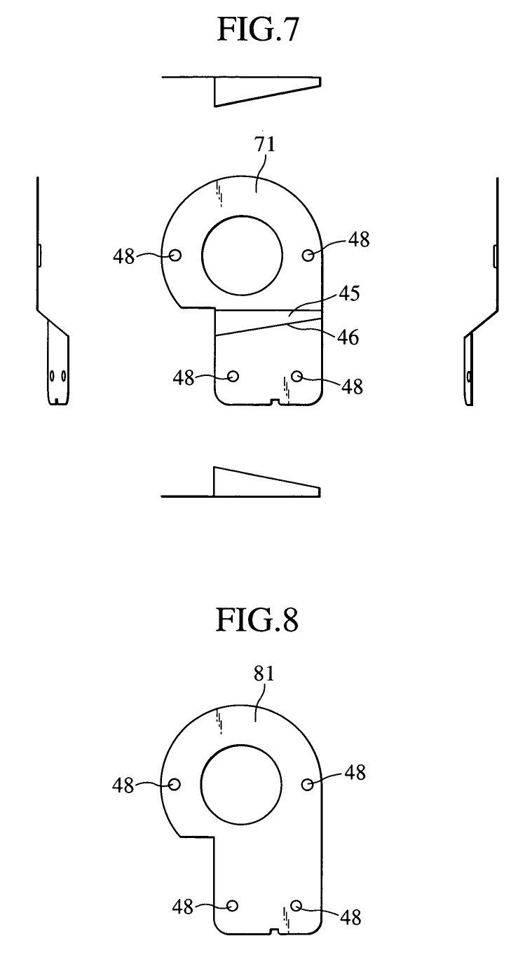

FIG. 7 is a diagram of a vibration suppressor plate in a third embodiment. The vibration suppressor plate 71 shown in FIG. 7 is employed to be fixed to an upper face of an upper fixed drum 14 using screws and/or an adhesive such as a two-sided adhesive tape. In order to fix the upper face of the upper fixed drum 14 and face of a cassette holder that differ in angle, the vibration suppressor plate 71, as with the vibration suppressor plate of FIG. 4, has folds 45, 46 and is bent to form a desired angle. The vibration suppressor plate 71 also has screw installation holes 48 to be used to screw down the plate.

(Fourth Embodiment)

FIG. 6 is a schematic view of an upper fixed drum 14 in a fourth embodiment. This embodiment applies when an upper face of the upper fixed drum 14 is approximately level with a face of a cassette holder 4. FIG. 8 is a diagram of a vibration suppressor plate in the fourth embodiment.

The vibration suppressor plate 81 shown in FIG. 8 is constructed into an approximately flat plate form, and this vibration suppressor plate is effective for a rotating magnetic head drum device 1 that adopts the construction shown FIG. 6. Since an upper face of the upper fixed drum 14 is approximately level with a face of a cassette holder 4, the vibration suppressor plate 81 can be constructed into an approximately flat plate form without folds. This, in turn, allows component costs to be minimized.

In FIG. 6, the entire upper fixed drum 14 is processed to be approximately level with the face of the cassette holder 4. The construction shown in FIG. 6 is also effective when part of the upper fixed drum 14 is processed to be approximately level.

In FIG. 6, although screw holes for installing a vibration suppressor plate are not shown, these screw holes may be provided as necessary in the upper face of the upper fixed drum 14. Alternatively, as shown in FIG. 8, screw installation holes 48 may be provided.

1. A magnetic recording and reproducing apparatus, comprising:
a lower fixed drum with an outer peripheral side face formed as a tape-traveling surface for guiding a magnetic recording tape;
an upper fixed drum fixed coaxially with the lower fixed drum, the upper fixed drum having an outer peripheral face as a second tape-traveling surface for guiding the magnetic recording tape;
a rotating magnetic head drum device with a middle rotating drum installed in a coaxially rotatable form between the lower fixed drum and the upper fixed drum, the middle rotating drum having a magnetic head;
a mechanism chassis for securing a bottom face of the lower fixed drum; and
a cassette holder secured to the mechanism chassis;
wherein an upper face of the upper fixed drum is secured to the cassette holder via a vibration suppressor plate.

2. The magnetic recording and reproducing apparatus according to claim 1, wherein:
the upper fixed drum has convex portions on the upper face thereof;
the vibration suppressor plate is formed with opposed claws at sections which abut on the convex portions; and
the opposed claws of the vibration suppressor plate are secured to the convex portions.

3. The magnetic recording and reproducing apparatus according to claim 1, wherein the upper fixed drum and the vibration suppressor plate are fixed using screws and/or an adhesive tape.

4. The magnetic recording and reproducing apparatus according to claim 1, wherein:
the upper face of the upper fixed drum and the face of the cassette holder differ in angle, and
the vibration suppressor plate has folds and is bent to form an angle corresponding to the difference of the angle.

5. The magnetic recording and reproducing apparatus according to claim 1, wherein:
the upper face of the upper fixed drum approximately level with the face of the cassette holder, and
the vibration suppressor plate is constructed into an approximately flat plate form without folds.
